(19) United States
(12) Patent Application Publication
(10) Pub. No.: US 2011/0310108 A1
(43) Pub. Date: Dec. 22, 2011

(54) INFORMATION PROCESSING SYSTEM, INFORMATION PROCESSING METHOD, AND INFORMATION PROCESSING APPARATUS

(76) Inventor: Hisakazu Shiraki, Kanagawa (JP)

(21) Appl. No.: 13/157,858

(22) Filed: Jun. 10, 2011

(30) Foreign Application Priority Data
Jun. 18, 2010 (JP) P2010-139718

(51) Int. Cl. G06F 13/14

(52) U.S. Cl. 345/520

(57) ABSTRACT

An information processing apparatus includes a graphics processing unit capable of dividing processing on an image into a plurality of threads, and executing processing on the image, a determining section configured to search for a thread parameter with which the graphics processing unit is capable of executing processing at the highest speed under a given image-processing condition, and to determine the thread parameter as an optimum thread parameter, a transferring section configured to establish a correspondence between the image-processing condition and the optimum thread parameter determined by the determining section, and to accumulate the image-processing condition and the optimum thread parameter in a database via a transmission line, and a setting section configured to obtain the optimum thread parameter from the database via the transmission line, and to set the optimum thread parameter to the graphics processing unit.

### BACKGROUND

The present disclosure relates to an information processing system executing effect processing on an image by using a GPU (Graphics Processing Unit), an information processing method, and an information processing apparatus.

In recent years, enhanced performance and high functionality of general-purpose computer hardware enable image processing by using general-purpose computer hardware, which only dedicated hardware was able to implement before. In the general-purpose computer hardware, specifically, CPUs (Central Processing Unit) and RAMS (Random Access Memory) used as main memories exhibit extremely high speed, and as a result, complicated effect processing with respect to large-capacity image data may be performed in an economic and satisfying time period.

Image processing may be performed at a further higher speed by introducing GPU (Graphics Processing Unit) which is an arithmetic processing device designed so as to be specialized in parallel arithmetic processing. The parallel arithmetic processing by GPU is implemented by a mechanism including issuing the same instructions to a plurality of arithmetic units and executing the same instructions by the respective arithmetic units independently. To the contrary, in CPU, different instructions are issued to a plurality of arithmetic units and the arithmetic units execute different instructions, respectively. Therefore, GPU may exhibit enhanced performance in processing in which arithmetic results of part of processing do not affect the entire processing such as image processing. To the contrary, CPU is suitable for sequential processing.

Further, recently, a technical field of GPGPU (General-Purpose computing on Graphics Processing Units) which enables GPU not only to perform image processing but also to be used for other numerical processing is known.

Japanese Patent Application Laid-open No. 2008-226038 (paragraph 0005) (hereinafter referred to as Patent Document 1) discloses a system searching for apparatuses connected to a network and displaying listing information on resource information (information on specs and performance) on the respective apparatuses. It is described that, in this system, when searching for resource information on the respective apparatuses, based on search conditions (retrieval protocol, communication system used for search, scope of search, and the like) input by a user, the number of threads is optimized in a case where a GPU executes display processing of a search result of apparatuses. By optimizing the number of threads, overconsumption of resources due to generation of threads more than necessary through display processing of resource information, and nonachievement of the purpose of improvement of processing speed by sharing display processing due to the too few threads, on the contrary, are prevented.

In processing such as effects on image data by a GPU, selection of the number of threads (thread parameter) is an important key to determine a processing speed. However, the optimum number of threads (thread parameter) depends on image-processing conditions such as specs of a GPU, an image size, and processing contents of an effect (effect parameters such as kind of effect and tap size). In an image editing environment using a computer, an image-processing condition including an image size to be output, effect processing contents, and the like may be freely set by a user. As a result, the number of kinds of image-processing condition becomes enormous. It is extremely inefficient for a user to find and set an optimum thread parameter under an image-processing condition by himself every time.

Alternatively, assuming that a developer of an effect previously determines optimum thread parameters for all the combinations of image-processing conditions, it is predicted that it takes enormous time and effort, which is not a realistic approach after all.

### SUMMARY

In view of the above-mentioned circumstances, it is desirable to provide an information processing system which may obtain optimum thread parameters efficiently depending on image-processing conditions and make the overall image processing efficient, an information processing method, and an information processing apparatus.

According to an embodiment of the present disclosure, there is provided an information processing system, including a plurality of information processing apparatuses, a database, and a transmission line connecting the processing apparatuses and the database. Each of the information processing apparatuses includes a graphics processing unit capable of dividing processing on an image into a plurality of threads, and executing processing on the image, a determining section configured to search for a thread parameter with which the graphics processing unit is capable of executing processing at the highest speed under a given image-processing condition, and to determine the thread parameter as an optimum thread parameter, a transferring section configured to establish a correspondence between the image-processing condition and the optimum thread parameter determined by the determining section, and to accumulate the image-processing condition and the optimum thread parameter in the database via the transmission line, and a setting section configured to obtain the optimum thread parameter from the database via the transmission line, and to set the optimum thread parameter to the graphics processing unit.

According to the present disclosure, in a case of newly obtaining the optimum thread parameter under a given image-processing condition, the determining section searches for a thread parameter with which the graphics processing unit in the information processing apparatus is capable of executing processing at the highest speed under the image-processing condition, and determines it as the optimum thread parameter. Further, a correspondence between the image-processing condition and the optimum thread parameter determined by the determining section is established, and the image-processing condition and the optimum thread parameter are transferred to the database via the transmission line to be accumulated in the database. Therefore, in a case where the optimum thread parameter under a given image-processing condition exists in the database, the information processing apparatus may obtain the optimum thread parameter from the database via the transmission line, and set it to the graphics processing unit. Therefore, according to the present disclosure, optimum thread parameters may be obtained efficiently under a wide variety of image-processing conditions, and images may be edited efficiently. Further, according to the present disclosure, one database is shared by a plurality of information processing apparatuses, whereby optimum thread parameters are obtained more efficiently.

The image-processing condition at least includes the kind of the graphics processing unit, the size of the image, and processing contents of the image. Therefore, this technology is adaptable to future increase of the image-processing condition relating to the emergence of higher-performance graphics processing units.

The setting section may be configured to set the optimum thread parameter determined by the determining section to the graphics processing unit. Therefore, image processing may be immediately executed under a new image-processing condition.

The determining section may be configured to measure, while updating a thread parameter set to the graphics processing unit, time required for processing for each thread parameter under a given image-processing condition, and to determine a thread parameter which makes the time required for processing the smallest as an optimum thread parameter. Therefore, a thread parameter which makes the time required for processing the smallest may be determined reliably.

The determining section may be capable of setting an upper limit of the thread parameter, and be configured to determine the optimum thread parameter within the range failing to exceed the set upper limit. Therefore, this technology is adaptable to a case where an upper limit of the thread parameter is set to the graphics processing unit.

According to another embodiment of the present disclosure, there is provided an information processing method, including determining, by a determining section of an information processing apparatus, a thread parameter with which a graphics processing unit of the information processing apparatus is capable of executing processing at the highest speed under a given image-processing condition as an optimum thread parameter, establishing, by a transferring section of the information processing apparatus, a correspondence between the image-processing condition and the optimum thread parameter determined by the determining section, and transferring the image-processing condition and the optimum thread parameter to a database via a network to accumulate the image-processing condition and the optimum thread parameter in the database, and obtaining, by a setting section of the information processing apparatus, the optimum thread parameter from the database via the network, and setting the optimum thread parameter to the graphics processing unit.

According to another embodiment of the present disclosure, there is provided an information processing apparatus, including a graphics processing unit capable of dividing processing on an image into a plurality of threads, and executing processing on the image, a determining section configured to determine a thread parameter with which the graphics processing unit is capable of executing processing at the highest speed under a given image-processing condition as an optimum thread parameter, a transferring section configured to establish a correspondence between the image-processing condition and the optimum thread parameter determined by the determining section, and to transfer the image-processing condition and the optimum thread parameter to a database via a transmission line to accumulate the image-processing condition and the optimum thread parameter in the database, and a setting section configured to obtain the optimum thread parameter from the database via the transmission line, and to set the optimum thread parameter to the graphics processing unit.

As described above, according to the present disclosure, optimum thread parameters may be obtained efficiently depending on image-processing conditions and the overall image processing may be executed efficiently.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a structure of an image editing system using a computer according to an embodiment of the present disclosure;

FIG. 2 is a block diagram showing the structure of hardware of an editing apparatus of FIG. 1;

FIG. 3 is a flowchart showing the flow of effect processing;

FIG. 4 is a diagram showing an example of an editing environment screen of the editing apparatus of FIG. 1;

FIG. 5 is a diagram showing an example of an editing environment screen for setting defocus parameters;

FIG. 6 is a flowchart showing an image processing flow in a case of applying an effect on image data by using a GPU in the editing apparatus of FIG. 1;

FIG. 7 is a block diagram schematically representing image processing functions of the editing apparatus of FIG. 1;

FIG. 8 is a conceptual diagram relating to thread parameter definition;

FIG. 9 is a conceptual diagram relating to thread parameter definition also;

FIG. 10 is a diagram explaining a thread parameter;

FIG. 11 is a flowchart showing a procedure of searching for the optimum number of threads by the editing apparatus of FIG. 1; and

FIG. 12 is a flowchart showing a procedure of searching for the optimum number of threads by an editing apparatus of Modified Example 1.

### DETAILED DESCRIPTION OF EMBODIMENTS

Hereinafter, an embodiment of the present disclosure will be described with reference to the drawings.

### First Embodiment

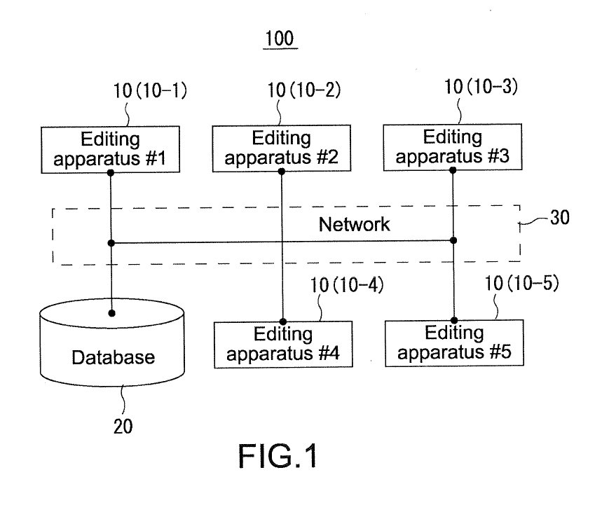

FIG. 1 is a diagram showing a structure of an image editing system as an information processing system according to an embodiment of the present disclosure.

(Image Editing System)

As shown in FIG. 1, an image editing system 100 includes a plurality of editing apparatuses 10 (10-1 to 10-5) being information processing apparatuses, a database 20, and a network 30 being a transmission line connecting them.

The database 20 accumulates a large quantity of image data and the like, and downloads, in response to an image selecting request from the editing apparatus 10, appropriate image data via the network 30 onto the editing apparatus 10. Further, the database 20 may download not only image data being an editing target but also thumbnailed reduced-size image data obtained by reducing the size of the image data in response to a request from the editing apparatus 10. Further, in the database 20, combinations of an image-processing condition and an optimum thread parameter obtained by the editing apparatuses 10 (10-1 to 10-5) are accumulated.

Each of the editing apparatuses 10 (10-1 to 10-5) is an apparatus capable of individually executing processing such as an effect on image data downloaded from the database 20 via the network 30 based on an operation input by an editor. The editing apparatus 10 is, more specifically, an information processing apparatus including computer hardware.

(Structure of Editing Apparatus 10)

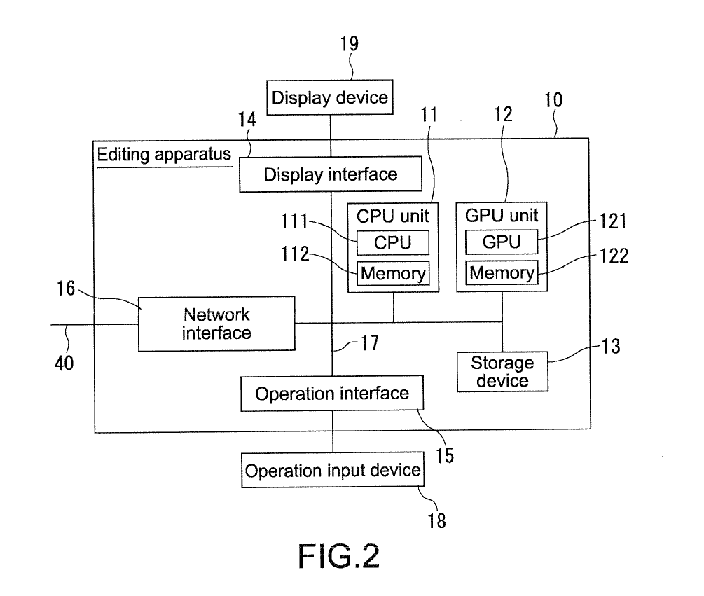

FIG. 2 is a block diagram showing the structure of hardware of the editing apparatus 10.

As shown in FIG. 2, the editing apparatus 10 includes a CPU unit 11, a GPU unit 12, a storage device 13, a display interface 14, an operation interface 15, a network interface 16, and a bus 17 connecting them each other.

The CPU unit 11 includes a CPU 111 and a memory 112 (hereinafter, referred to as “CPU memory”), and executes a program stored in the CPU memory 112, to thereby execute instructions with regard to various kinds of arithmetic processing in the CPU memory 112. The CPU unit 11 interprets commands by a user input from an operation input device 18 connected to the operation interface 15, to thereby reflect them to the behavior of the program. For example, the CPU unit 11 controls to download image data accumulated in the database 20 based on commands by a user and the like and to store the image data in the storage device 13, reads out image data stored in the storage device 13 in the CPU memory 112, and executes processing such as an effect on the image data. The image data held in the CPU memory 112 is supplied to the display interface 14, drawing-processed to be visible drawing data in the display interface 14, merged with drawing data of an image processed by the GPU unit 12 (described later) as necessary, and output to a display device 19. Further, the CPU unit 11 may control to merge processed image data held in the CPU memory 112 with image data processed by the GPU unit 12 as necessary, to write back the image data in the storage device 13, and to transfer edited image data written back in the storage device 13 to the database 20 via the network 30.

The GPU unit 12 includes a GPU 121 and a memory 122 (hereinafter, referred to as “GPU memory 122”), and may execute a program stored in the GPU memory 122, to thereby execute image processing such as an effect through parallel arithmetic processing in the GPU memory 122. Image data held in the GPU memory 122 is supplied to the display interface 14, drawing-processed to be visible drawing data in the display interface 14, merged with drawing data of an image processed by the above-mentioned GPU unit 12 as necessary, and output to the display device 19.

The display interface 14 is an interface to the display device 19, executes drawing process on image data supplied from the CPU unit 11 and the GPU unit 12, merges drawing data of an image processed by the CPU unit 11 and drawing data of an image processed by the GPU unit 12 as necessary, and supplies the merged data to the display device 19 as drawing data of one image. The processing by the display interface 14 is implemented by, for example, the above-mentioned GPU 121 or a GPU (not shown) additionally provided.

The operation interface 15 is an interface to the operation input device 18, supplies data and commands by a user input from the operation input device 18 to the CPU unit 11, and the like.

The storage device 13, for example, stores unedited image data obtained from the database 20 and edited image data, and accumulates various programs causing the CPU unit 11 and the GPU unit 12 to execute editing process and the like.

The network interface 16 is an interface for connecting to the network 30.

(Effect Processing)

A flow of processing in a case where the editing apparatus 10 of FIG. 2 applies an effect (special effect) on one or more frame images included in one scene being part of a moving image will be described.

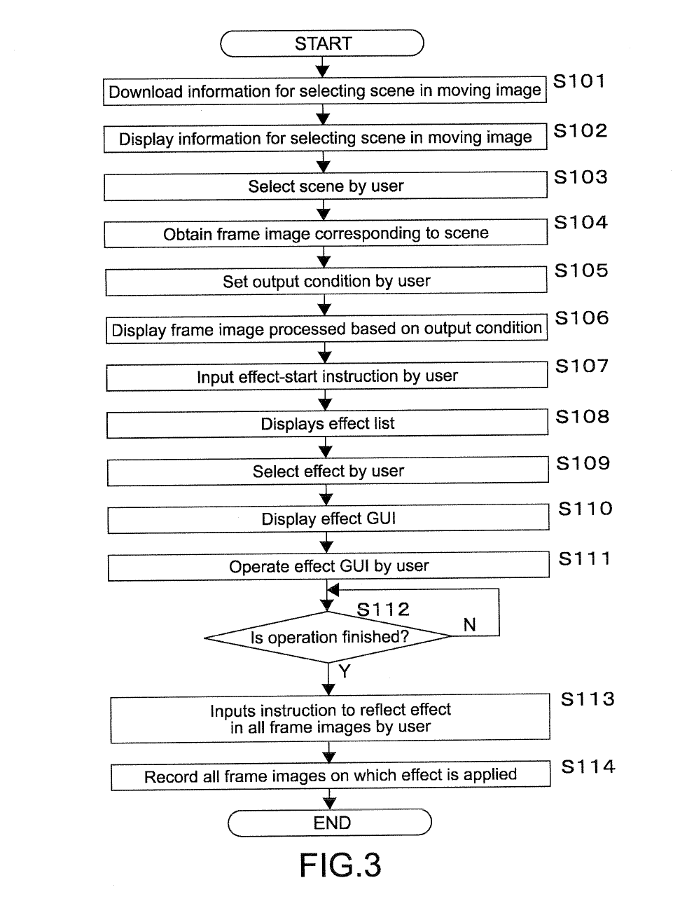

FIG. 3 is a flowchart showing the flow of the effect processing.

First, the CPU 111 in the editing apparatus 10 downloads information for selecting a scene in a moving image from the database 20 according to an instruction by a user (Step S101), and displays the downloaded information for selecting a scene on the display device 19 (Step S102). Here, the information for selecting a scene is, for example, image data obtained by reducing the resolution of a frame image representing the scene (thumbnail image) or the like.

Next, in a case where a scene on which a user wishes to apply an effect is selected by a user from the information for selecting a scene displayed on the display device 19 by using the operation input device 18 such as a mouse (Step S103), the CPU 111 in the editing apparatus 10 requests the database 20 to download one or more frame images corresponding to the selected scene, obtains the one or more frame images, and stores them in the storage device 13 (Step S104).

Next, by using the operation input device 18, an output condition of an image is set by a user (Step S105). The output condition is a condition setting an output format of a moving image, and includes enlargement/reduction rate, frame rate, and the like, for example. The CPU 111 reads out each frame image corresponding to the selected scene from the storage device 13 in the CPU memory 112. The CPU 111 enlarges/reduces each frame image, changes the frame rate through interframe interpolation, and the like according to the above-mentioned output condition. Each frame image processed based on the output condition is displayed on an output image display window and a track display window of an editing environment screen (described later) (Step S106).

Next, an effect-start instruction is input by a user through the operation input device 18 (Step S107). Receiving the effect-start instruction, the CPU 111 displays a list of effect programs previously prepared in the editing apparatus 10 on the display device 19 (Step S108). A plurality of effect programs are previously prepared in the editing apparatus 10. In a case where one effect is selected therefrom by a user (Step S109), an effect program corresponding to the selected effect is executed, and effect processing on a displayed frame image is executed.

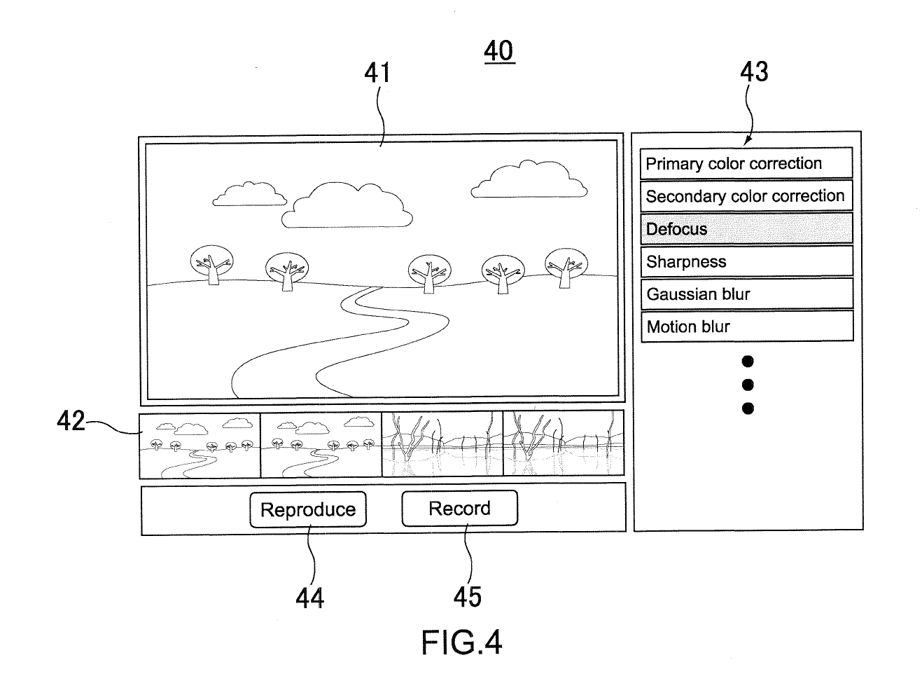

FIG. 4 is a diagram showing an example of an editing environment screen 40 of the editing apparatus 10. As shown in FIG. 4, an output image display window 41, a track display window 42, an effect candidate list 43, and the like are displayed on the editing environment screen 40. The output image display window 41 is a window on which a frame image enlarged/reduced according to an output condition is displayed as an effect-target image, or an effect-result image is displayed. The track display window 42 is a window on which a plurality of successive frame images corresponding to part of scenes selected by a user are simultaneously displayed. In the track display window 42, the horizontal direction represents the direction of time. By operating a slider (not shown) for selecting time positions in right-and-left horizontal directions through the operation input device 18 by a user, time positions of a plurality of frame images simultaneously displayed on the track display window 42 are moved (changed over). Through the changeover, a user may see all the frame images included in a selected scene. Further, one frame image to be displayed on the output image display window 41 may be selected from a plurality of frame images displayed on the track display window 42 through the operation input device 18 by a user. The effect candidate list 43 is a list of the kinds of effects to be applied on a frame image displayed on the output image display window 41. The kind of effect to be applied on a frame image displayed on the output image display window 41 is selected through the operation input device 18 such as a mouse by a user.

In a case where one effect is selected from the effect candidate list 43, the CPU 111 displays an effect GUI window for setting various parameters of the selected effect (Step S110). Parameters are adjusted for each item on the effect GUI window through the operation input device 18 such as a mouse by a user (Step S111).

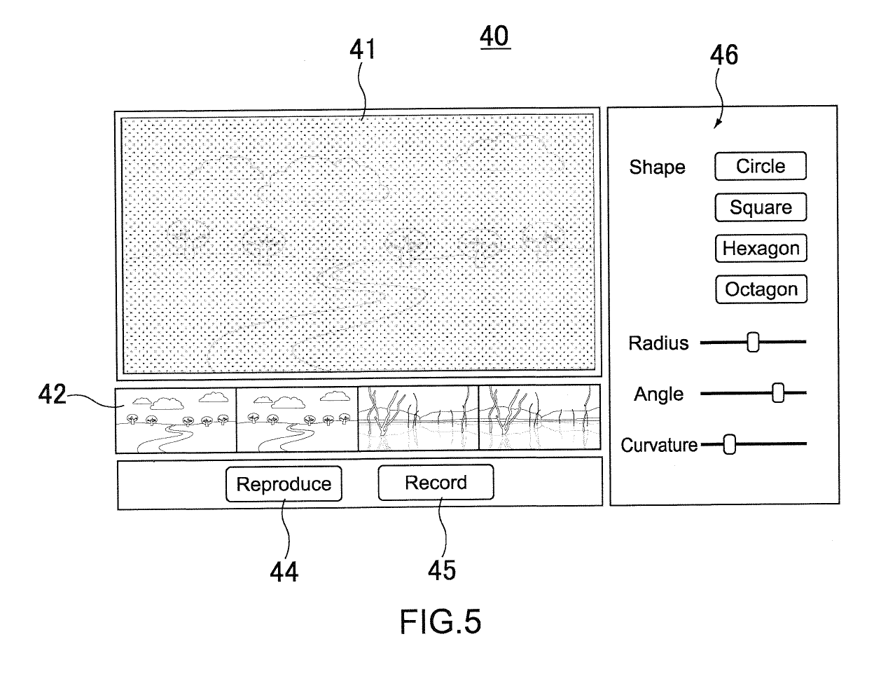

For example, a case where defocus is selected as the kind of effect will be described. In a case where defocus is selected, as shown in FIG. 5, an effect GUI window 46 for setting parameters of defocus is displayed on the editing environment screen 40. Through the effect GUI window 46 for defocus, a user may select the shape of iris by operating buttons and adjust parameters such as radius, angle, and curvature by operating sliders by using the operation input device 18 such as a mouse.

According to the parameters selected through the effect GUI window 46 by a user, the CPU 111 executes effect processing on a frame image displayed on the output image display window 41. In this case, the effect processing is executed in real time to selecting operation of each parameter, and reflected in a frame image displayed on the output image display window 41, whereby the optimum parameter may be efficiently selected for each item.

After the parameters are adjusted (Step S112, Y), a user inputs an instruction including parameter adjusting results to reflect effects in all the frame images included in the selected scene into the CPU 111 by using the operation input device 18 (Step S113). Such instructions are made by clicking processing output buttons provided on the editing environment screen 40, and the like. As shown in FIGS. 4 and 5, the processing output buttons include a reproduce button 44 and a record button 45. In a case where the reproduce button 44 is operated by a user, an effect including adjusting results of parameters applied on a frame image selected by a user is similarly applied on other frame images included in the scene, and a moving image corresponding to the scene is output to the output image display window 41. A user may watch the moving image displayed on the output image display window 41, and confirm the results of the effect applied on the whole scene. Further, in a case where the record button 45 is operated by a user, an effect including adjusting results of parameters applied on a frame image selected by a user is similarly applied on other frame images included in the scene, and written in the storage device 13 (Step S114).

Note that the defocus effect processing has been described here, but the above description applies to other kinds of effect processing.

Next, processing in a case of applying an effect on image data by using the GPU 121 will be described.

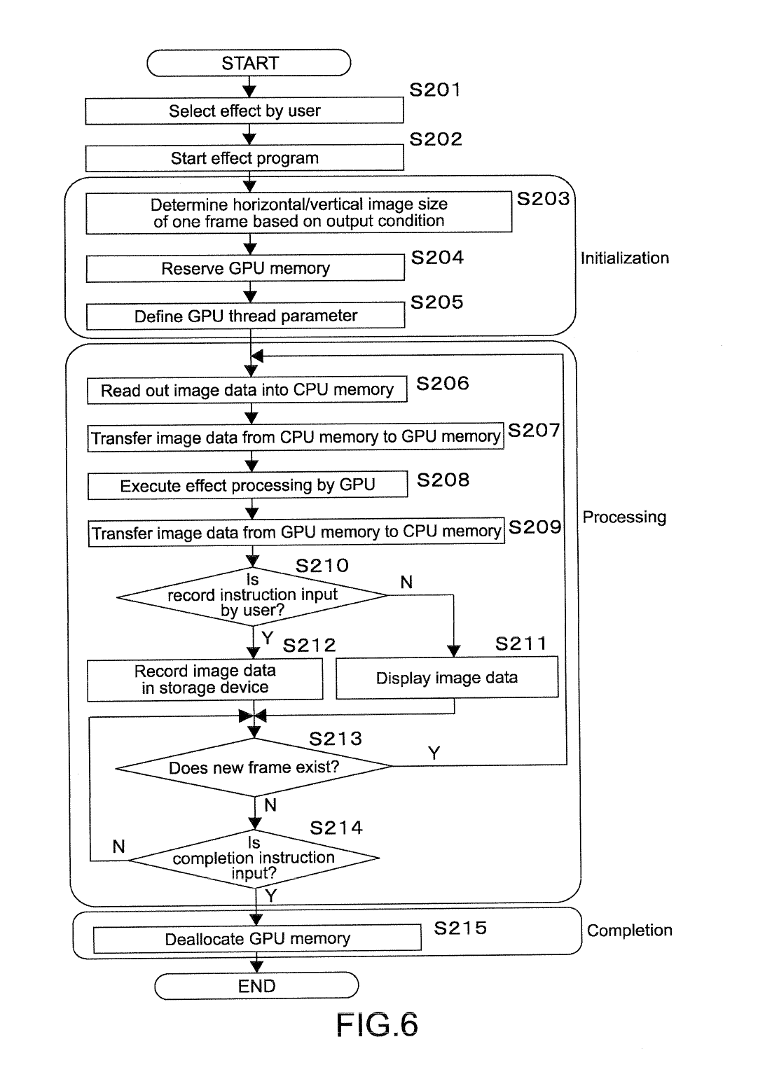

FIG. 6 is a flowchart showing an image processing flow in a case of applying an effect on image data by using the GPU 121.

First, an effect is selected by a user (Step S201). This operation is performed, as described above, by selecting an effect from the effect candidate list 43 shown in FIG. 4. In a case where an effect is selected, the CPU 111 starts an effect program corresponding to the selected effect (Step S202). After the effect program is started, the CPU 111 executes the following initializing process.

As initialization, the CPU 111 determines a horizontal/vertical image size of one frame based on an output condition of image data set by a user (Step S203). Next, the CPU 111 instructs the GPU 121 to reserve the GPU memory 122 for the horizontal/vertical image size of one frame (Step S204). Subsequently, the CPU 111 defines the number of threads that the GPU unit 12 executes processing (Step S205). Operations defining the number of threads will be described later.

The initializing process is as described above. Subsequently, the flow proceeds to image processing.

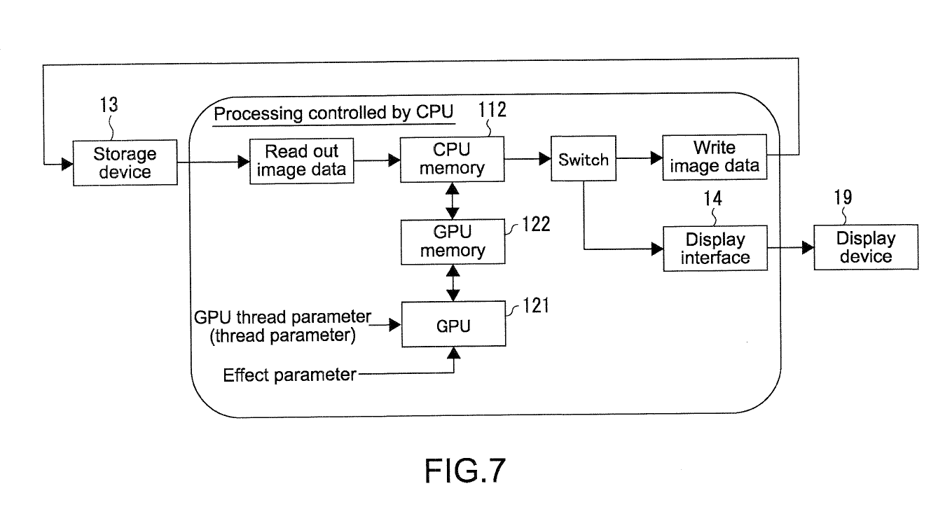

FIG. 7 is a block diagram schematically representing image processing functions of the editing apparatus 10. As shown in FIG. 7, first, as processing after the initialization, image data is read out from the storage device 13 into the CPU memory 112 (Step S206). Here, the image data read out into the CPU memory 112 is image data (frame image) of a frame number in moving image data designated by the CPU unit 11. The frame number designated by the CPU unit 11 is the frame number of a frame image selected by a user through the track display window 42 of FIG. 5. Further, in a case where the reproduce button 44 or the record button 45 on the editing environment screen 40 of FIG. 5 is operated by a user and an effect including adjusting results of parameters is applied on all the frame images, frame numbers of the beginning frame image to the last frame image in a scene are sequentially designated.

Next, the image data loaded in the CPU memory 112 is transferred to the GPU memory 122 reserved in the above-mentioned initialization (Step S207). After that, while reading out the image data from the GPU memory 122, the GPU 121 executes effect processing on image data according to an effect program to be started (Step S208), and writes back the result in the GPU memory 122. When the effect processing is completed, the GPU 121 returns the image data from the GPU memory 122 to the CPU memory 112 (Step S209).

Here, the CPU 111 detects whether the record button 45 is operated by a user or not (Step S210). In a case where the record button 45 is not operated by a user (Step S210, N), the CPU 111 supplies image data on which an effect is applied from the CPU memory 112 to the display interface 14. The display interface 14 executes drawing process on image data supplied from the CPU memory 112, and supplies drawing data to the display device 19. As a result, an image is displayed on the output image display window 41 of FIG. 5 (Step S211). Behavior similar to the behavior of Step S211 is performed in a case where the reproduce button 44 is operated by a user. However, in a case where the reproduce button 44 is operated by a user, in order to repeatedly apply an effect in sequence to all the frame images included in a scene and to repeatedly display the result, the flow returns from Step S213 to Step S206, whereby processing of reading out the next effect-target image data from the storage device 13 in the CPU memory 112 is repeated.

Further, in a case where the CPU 111 detects that the record button 45 is operated by a user (Step S210, Y), the CPU 111 writes back image data on which an effect is applied from the CPU memory 112 in the storage device 13 (Step S212). Further, in a case where the record button 45 is operated by a user, in order to repeatedly apply an effect in sequence to all the frame images included in a scene and to repeatedly record the result in the storage device 13, the flow returns from Step S213 to Step S206, whereby processing of reading out the next effect-target image data from the storage device 13 in the CPU memory 112 is repeated.

In a case where the record button 45 and the reproduce button 44 are not operated by a user, similarly, the flow proceeds to Step S211, whereby image data on which an effect is applied is displayed. In this case, after supplying image data to the display interface 14, the CPU 111 is in a waiting state for the next instruction. Under the waiting state, for example, in a case where an instruction to complete effect processing, such as an operation for closing the effect GUI window 46 of FIG. 5 by a user, is input by a user (Step S214, Y), the CPU 111 deallocates the GPU memory 122 (Step S215) and completes the effect processing.

Next, the procedure of defining a thread parameter for the GPU unit 12 will be described.

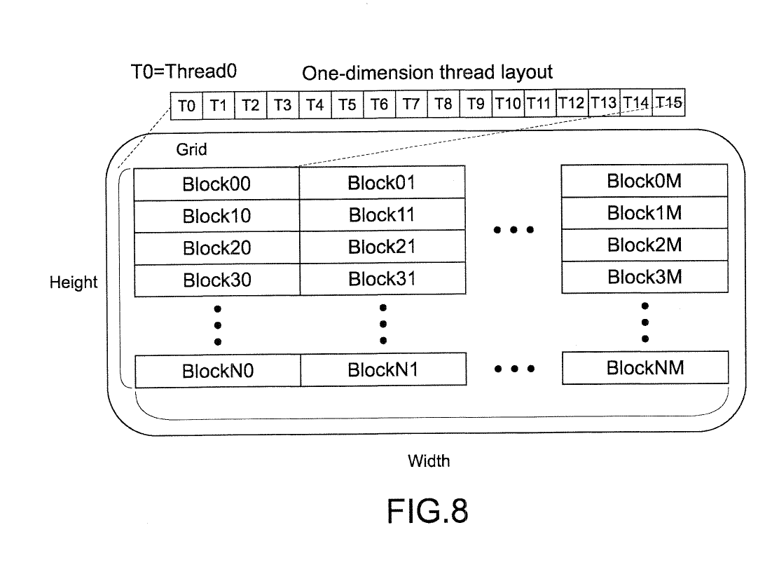

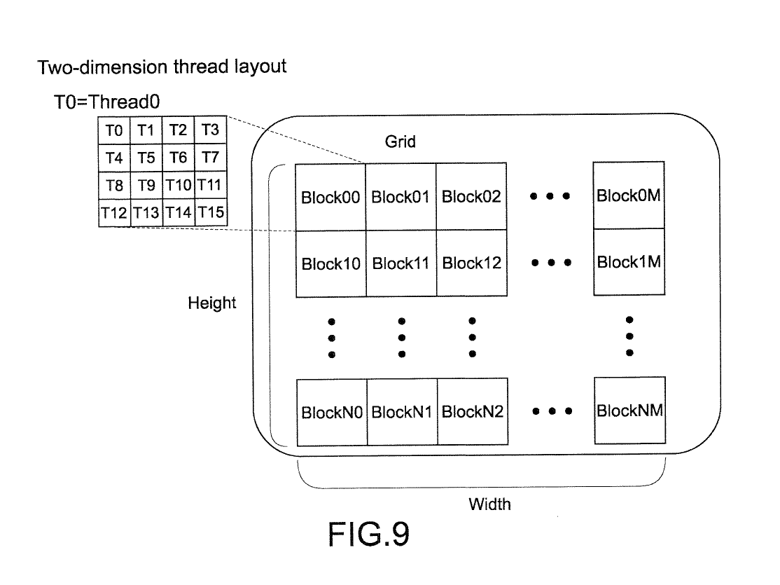

In development of GPGPU, CUDA (registered trademark), a development environment supplied by NVIDIA Corporation (USA), is known. In the programming of CUDA (registered trademark), “Grid”, “Block”, and “Tread” are used as parameters dividing actual processing into threads. FIGS. 8 and 9 are conceptual diagrams showing them. For example, taking image processing executing convolution operation multiplying the whole screen by filter coefficient for instance, “Tread” is the parameter corresponding to pixels to which processing to execute product-sum operations by filter coefficient is distributed, and “Block” corresponds to a rectangular area of an image obtained by combining “Treads”. Further, “Grid” corresponds to the full screen obtained by combining “Blocks”. Here, assuming that “Grid” corresponds to the full screen, the layout of “Blocks” and “Treads” is freely set by a developer. A developer may set the layout in one dimension as shown in FIG. 8 or in two dimension as shown in FIG. 9. For example, the number of “Blocks” in the horizontal direction (Block_{X}) and the number of “Blocks” in the vertical direction (Block_{Y}) are defined by Expression (1) and Expression (2), respectively, in which Thread_{X} represents the number of “Treads” in the horizontal direction, Thread_{Y} represents the number of “Treads” in the vertical direction, “Width” represents the number of pixels of an image in the horizontal direction, and “Height” represents the number of pixels of the image in the vertical direction.

Block_{X}=Width/Thread_{X} (1)

Block_{Y}=Height/Thread_{Y} (2)

In this embodiment, for example, a case where Thread_{X}, Thread_{Y}, Block_{X}, and Block_{Y} are supplied to the GPU unit 12 as thread parameters is assumed.

Depending on the kind of GPU, there is a case where Thread_{X} and Thread_{Y} may be supplied as thread parameters.

The scheduling algorithm of overall processing with respect to arbitrary thread parameters depends on CUDA (registered trademark). Although the details are not disclosed, it is known that the speed of image processing changes depending on how the thread parameters are supplied. Further, optimum thread parameters are different depending on conditions such as the size of a target image, processing contents (kind of effect, effect parameter) for “Tread”, and the kind of the GPU 121 executing processing. For example, by adjusting thread parameters such as Thread_{X}, Thread_{Y}, Block_{X}, and Block_{Y}, the result obtained by adding an effect to a moving image may or may not be drawn in real time.

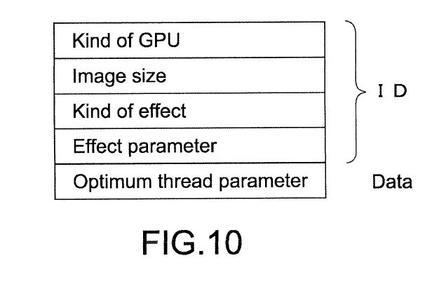

According to this embodiment, there is provided a technology which may efficiently define the optimum thread parameter corresponding to an image-processing condition. That is, each of the editing apparatuses 10 (10-1 to 10-5) searches for the number of threads that the GPU 121 may process at the highest speed under an image-processing condition, and determines it as the optimum thread parameter. Here, the image-processing condition at least includes, more specifically, the kind of GPU, the size of an image, and processing contents (kind of effect, effect parameter) of an effect as shown in FIG. 10, for example. The kind of GPU may be specs information on the GPU.

Each of the editing apparatuses 10 (10-1 to 10-5) defines the image-processing condition as ID and the optimum thread parameter under the image-processing condition as data, establishes a correspondence between the ID and the data, and transfers the ID and the data to the database 20 of FIG. 1 to accumulate the ID and the data in the database 20. Further, each of the editing apparatuses 10 (10-1 to 10-5) reuses optimum thread parameters accumulated in the database. In order to reuse the optimum thread parameters accumulated in the database 20, each of the editing apparatuses 10 (10-1 to 10-5) transmits an inquiry including an ID being an image-processing condition to the database 20. The database 20 searches for data of the optimum thread parameter corresponding to the ID included in the inquiry, and returns it to the editing apparatus 10 being an inquiry source. The details will be described below.

First, the procedure of searching for an optimum thread parameter corresponding to an image-processing condition by the editing apparatus 10 will be described.

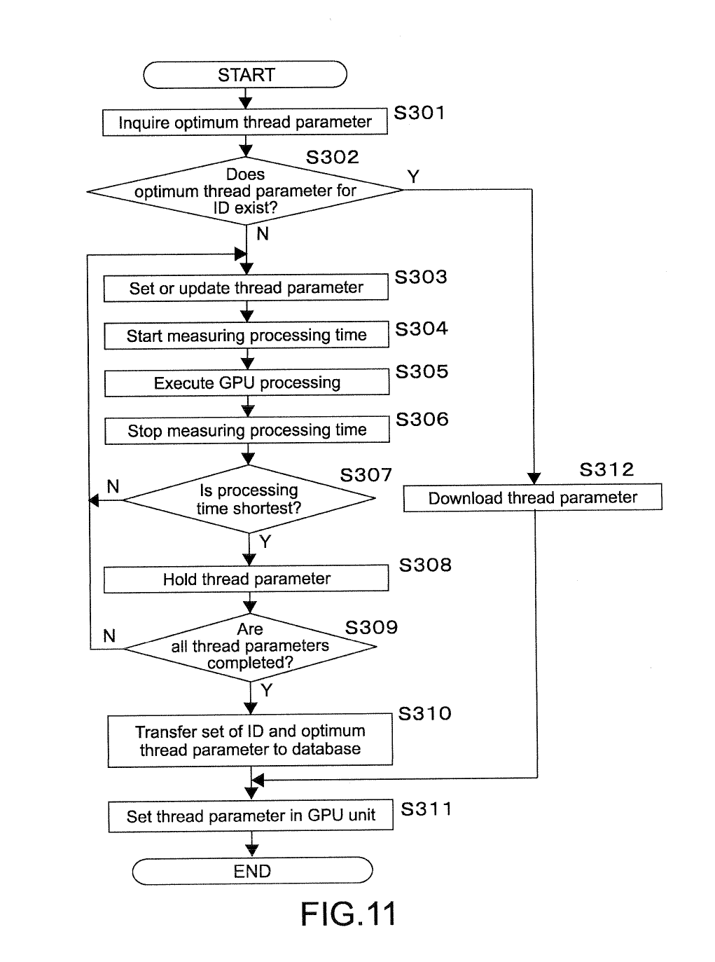

FIG. 11 is a flowchart showing the procedure.

First, the CPU 111 of the editing apparatus 10 defines the combination of the kind of the GPU 121, an image size, and processing contents (kind of effect, effect parameter) of an effect, which is a condition of image processing to be executed, as an ID, and inquires of the database 20 via the network 30 whether data of the optimum thread parameter for the ID exists (Step S301).

Based on a reply from the database 20, the CPU 111 determines whether data of the optimum thread parameter for the ID being the image-processing condition exists in the database 20 (Step S302). In a case where data of the optimum thread parameter for the ID exists (Step S302, Y), the CPU 111 (setting section) downloads the data of the optimum thread parameter from the database 20 (Step S312), sets the data to the GPU unit 12, and causes the GPU unit 12 to execute effect processing on image data (Step S311).

In a case where the optimum thread parameter for the ID, which is a condition of image processing to be executed, does not exist in the database 20 (Step S302, N), the CPU 111 (determining section) determines the optimum thread parameter by searching as follows.

The determination is performed by
1. setting or updating a search-target thread parameter (Step S303),
2. starting measuring a processing time (Step S304),
3. executing processing by the GPU 121 (Step S305),
4. stopping measuring the processing time (Step S306),
5. determining whether the processing time is the shortest (Step S307),
6. holding a thread parameter which makes the processing time the shortest (Step S308), and repeating these steps until measurement with respect to all the search-target thread parameters are completed (Step S309).

Therefore, the CPU 111 (determining section) determines the thread parameter making the processing time the shortest (enabling processing at the highest speed) from all the search-target thread parameters as the optimum thread parameter.

Here, the thread parameter includes, for example, Thread_{X}, Thread_{Y}, Block_{X}, and Block_{Y}. Block_{X} and Block_{Y} are uniquely determined by the above-mentioned Expression (1) and Expression (2) when Thread_{X}, Thread_{Y}, Width, and Height are given. Therefore, the CPU 111 sets the default “1” to each of Thread_{X} and Thread_{Y} for the first time around, and measures the time required to process an image. After that, while updating the combination of the values of Thread_{X} and Thread_{Y} for one cycle, the CPU 111 measures the time required to process the image every time the CPU 111 updates the combination.

Note that the purpose of the processing by the GPU 121 is to measure the processing time. Therefore, although the GPU memory 122 is used, it is not necessary to store the actual image data in the GPU memory 122. That is, it is not necessary to transfer image data from the CPU memory 112 to the GPU memory 122 as in the case of actual image processing.

After that, the CPU 111 (transferring section) generates an ID being an image-processing condition, which is a combination of the kind of the GPU 121, the size of image data, and processing contents (kind of effect, effect parameter) of an effect, and transfers the combination of the ID and data of the optimum thread parameter to the database 20 via the network 30 to accumulate the combination in the database 20 (Step S310). After that, the optimum thread parameter may be used as a candidate of a reply to an inquiry from each of the editing apparatuses 10 (10-1 to 10-5) in the image editing system 100.

Then, the CPU 111 (setting section) outputs the determined optimum thread parameter to the GPU unit 12, and cause the GPU 121 to execute actual image data processing (Step S311).

The above-mentioned search for the optimum thread parameter is executed at the stage of initialization after starting an effect of FIG. 7, and it is not necessary to execute the search for each frame. Further, since the effect processing time for one frame is about several ms to several tens of ms, even if the search is executed a hundred times, it takes about several seconds. Therefore, it is unlikely that waiting time of a user due to the search for the optimum thread parameter is in a problematic situation.

As described above, according to the editing apparatus 10 of this embodiment, in a case of newly obtaining the optimum thread parameter under a given image-processing condition, the CPU 111 searches for a thread parameter allowing the graphics processing unit in the editing apparatus 10 to execute processing at the highest speed under the image-processing condition, and determines it as the optimum thread parameter. Further, according to the editing apparatus 10 of this embodiment, in a case where the optimum thread parameter under an image-processing condition exists in the database 20, the CPU 111 may obtain the optimum thread parameter from the database 20 via the network 30 (transmission line), and supply it to the GPU unit 12. Therefore, in a case where the GPU 121 executes effect processing again under an image-processing condition used before, the GPU 121 may reuse a thread parameter accumulated in the database 20. Therefore, optimum thread parameters may be obtained efficiently under a wide variety of image-processing conditions, and images may be edited efficiently.

Further, according to the editing apparatus 10 of this embodiment, the one database 20 is shared by the plurality of editing apparatuses 10 (10-1 to 10-5), whereby optimum thread parameters are obtained more efficiently.

Further, according to the editing apparatus 10 of this embodiment, the combination of the kind of the GPU 121, the size of image data, and processing contents (kind of effect, effect parameter) of an effect is determined as the ID, and the combination of the ID and data of the optimum thread parameter is accumulated in the database 20. Therefore, this technology is adaptable to future increase of the kind of GPU, the kind of effect, the kind of effect parameter, and the like relating to the emergence of higher-performance GPUs, which is advantageous.

### Modified Example 1

In some kind of GPU 121, there may be a case where an upper limit up to, for example, 512 or 256 is set to the product of Thread_{X} and Thread_{Y}. In such a case, a thread parameter may be updated within a range that does not exceed the upper limit.

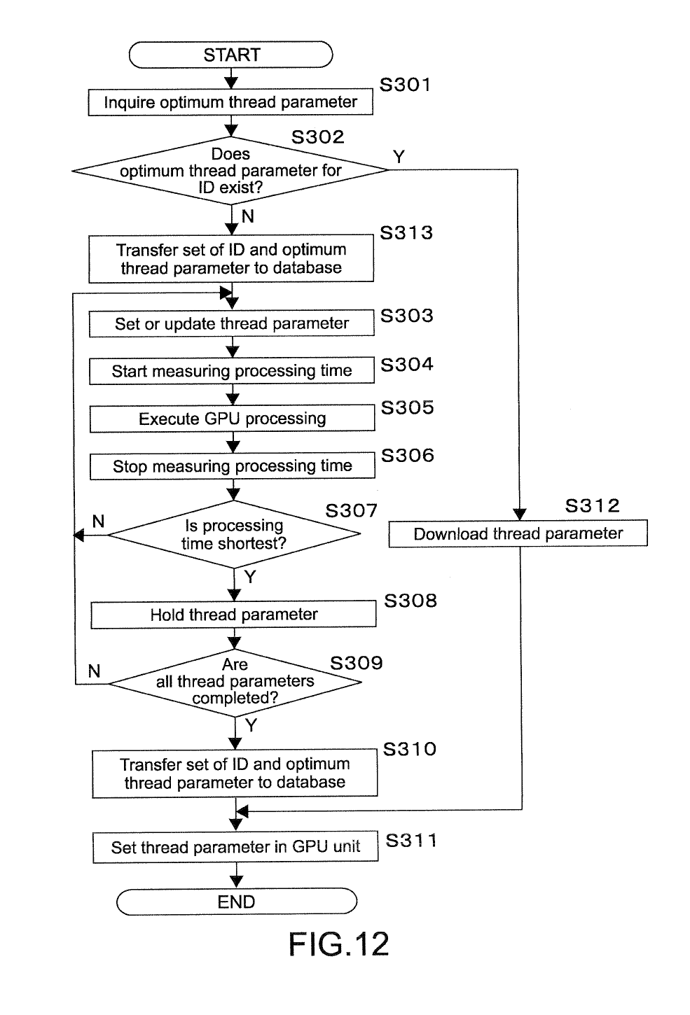

FIG. 12 is a flowchart showing an optimum thread parameter searching procedure in a case where the GPU 121 has the above-mentioned limitation.

In this example, after determining that data of an optimum thread parameter with respect to an ID does not exist in Step S302, the CPU 111 generates all the combinations of Thread_{X} and Thread_{Y} within a range in which the product of Thread_{X} and Thread_{Y} does not exceed the upper limit value depending on the kind of GPU 121 (Step S313). After that, in Step S303 to Step S309, a thread parameter employing a combination of Thread_{X} and Thread_{Y} making processing time by the GPU 121 shortest is determined as the optimum thread parameter from all the combinations of Thread_{X} and Thread_{Y}. Then, the combination of the determined optimum thread parameter and the ID is transferred to the database 20 (Step S310), the optimum thread parameter is output to the GPU unit 12, and the GPU 121 executes actual image data processing (Step S311).

### Modified Example 2

In some kind of GPU 121, there may be a case where the number of search-target thread parameters is too enormous to take much time. In such a case, not updating the values of Thread_{X} and Thread_{Y} by a predetermined value for one cycle, the values of Thread_{X} and Thread_{Y} may be updated by limiting the value to power-of-two.

### Modified Example 3

There is a case where an effect parameter of some kind of effect is repeatedly and frequently adjusted with respect to a specific frame through the editing environment screen 40 of FIG. 5 by a user. In this case, the CPU 111 may cause the GPU 121 to execute processing by using an arbitrary thread parameter in the adjustment, and may define the optimum thread parameter just before shifting to moving image processing such as reproducing or recording to be actually processed at a high speed.

Note that the present disclosure is not limited to the embodiment as described above, but may be variously modified within the scope of technological thought of the present disclosure.

The present disclosure contains subject matter related to that disclosed in Japanese Priority Patent Application JP 2010-139718 filed in the Japan Patent Office on Jun. 18, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system, comprising:
a plurality of information processing apparatuses;
a database; and
a transmission line connecting the processing apparatuses and the database, wherein
each of the information processing apparatuses includes
a graphics processing unit capable of dividing processing on an image into a plurality of threads, and executing processing on the image,
a determining section configured to search for a thread parameter with which the graphics processing unit is capable of executing processing at the highest speed under a given image-processing condition, and to determine the thread parameter as an optimum thread parameter,
a transferring section configured to establish a correspondence between the image-processing condition and the optimum thread parameter determined by the determining section, and to accumulate the image-processing condition and the optimum thread parameter in the database via the transmission line, and
a setting section configured to obtain the optimum thread parameter from the database via the transmission line, and to set the optimum thread parameter to the graphics processing unit.

2. The information processing system according to claim 1, wherein
the image-processing condition at least includes
the kind of the graphics processing unit,
the size of the image, and
processing contents of the image.

3. The information processing system according to claim 2, wherein
the setting section is configured to set the optimum thread parameter determined by the determining section to the graphics processing unit.

4. The information processing system according to claim 3, wherein
the determining section is configured to measure, while updating a thread parameter set to the graphics processing unit, time required for processing for each thread parameter under a given image-processing condition, and to determine a thread parameter which makes the time required for processing the smallest as an optimum thread parameter.

5. The information processing system according to claim 4, wherein
the thread parameter at least includes a combination of the numbers of threads in respective biaxial directions of an image.

6. The information processing system according to claim 5, wherein
the determining section is capable of setting an upper limit of the thread parameter, and is configured to determine the optimum thread parameter within the range failing to exceed the set upper limit.

7. An information processing method, comprising:
determining, by a determining section of an information processing apparatus, a thread parameter with which a graphics processing unit of the information processing apparatus is capable of executing processing at the highest speed under a given image-processing condition as an optimum thread parameter;
establishing, by a transferring section of the information processing apparatus, a correspondence between the image-processing condition and the optimum thread parameter determined by the determining section, and transferring the image-processing condition and the optimum thread parameter to a database via a network to accumulate the image-processing condition and the optimum thread parameter in the database; and
obtaining, by a setting section of the information processing apparatus, the optimum thread parameter from the database via the network, and setting the optimum thread parameter to the graphics processing unit.

8. An information processing apparatus, comprising:
a graphics processing unit capable of dividing processing on an image into a plurality of threads, and executing processing on the image;
a determining section configured to determine a thread parameter with which the graphics processing unit is capable of executing processing at the highest speed under a given image-processing condition as an optimum thread parameter;
a transferring section configured to establish a correspondence between the image-processing condition and the optimum thread parameter determined by the determining section, and to transfer the image-processing condition and the optimum thread parameter to a database via a transmission line to accumulate the image-processing condition and the optimum thread parameter in the database; and
a setting section configured to obtain the optimum thread parameter from the database via the transmission line, and to set the optimum thread parameter to the graphics processing unit.
